(19) United States
(12) Patent Application Publication
(10) Pub. No.: US 2009/0020091 A1
(43) Pub. Date: Jan. 22, 2009

(54) STARTING DEVICE FOR INTERNAL COMBUSTION ENGINES IN MOTOR VEHICLES

(76) Inventors: Thomas Botzenhard, Vaihingen/Enz (DE); Birgit Kuettmer, Sersheim (DE); Sven Hartmann, Stuttgart (DE); Klaus Heyers, Reutlingen (DE); Steffi Grellscheid, Tamm (DE); Walter Gerschwitz, Moensheim (DE); Karl-Otto Schmidt, Keltern (DE); Apostolos Tsakiris, Ludwigsburg (DE)

Correspondence Address: MICHAEL J. STRIKER, 103 EAST NECK ROAD, HUNTINGTON, NY, 11743, US

(21) Appl. No.: 11/913,617

(22) PCT Filed: May 8, 2006
(86) PCT No.: PCT/EP06/62124

§ 371 Date: May 7, 2008

(30) Foreign Application Priority Data
May 9, 2005 (DE) 102005021227.1

(51) Int. Cl. F02N 17/00

(52) U.S. Cl. 123/179.3

(57) ABSTRACT

The invention relates to a starter device (10) for internal combustion engines (15) in motor vehicles with a controller (19), a starter relay (12), a starter pinion (13) and a starter motor (11), whereby on each start/stop process in the stop phase (first step) the starter relay engages the starter pinion in the toothed ring (14) of the engine and in the start phase (second step) the engine is turned over by the starter motor. According to the invention, the starter pinion (13) may be engaged as quietly as possible for a subsequent starting process on switching off the engine (10) and held in position until starting, whereby, in the first step of the starting process, the armature (28) of the starter relay (12) is withdrawn with reduced force to a position with open switch contact (18) and held there until the start of the second step, whereupon the armature (28) closes the switch contact (18) of the starter motor with full force.

The present invention relates to a starting device for internal combustion engines in motor vehicles according to the general class of claim 1, with a starter relay according to the general class of claim 5.

### RELATED ART

Internal combustion engines of motor vehicles are typically started by a starter motor via a starter relay, which first engages a pinion of the starter motor in a toothed ring of the internal combustion engine and then connects—via a switch contact—the starter motor with the storage battery of the motor vehicle in order to turn the internal combustion engine over. It is also known to equip motor vehicles with an automatic start-stop system. This enables the internal combustion engine to be shut off automatically when the vehicle comes to a standstill for an extended period of time, e.g., at a red light. To continue driving, the internal combustion engine is automatically restarted. The stop state is detected, e.g., by registering the rotational speed of the drive wheels and, optionally, via a selector-lever position. The start state may be detected, e.g., via the actuation of a gas pedal.

The automatic start-stop system has the advantage of reducing fuel consumption and environmental impact during the stop state. It is unfavorable, however, that the pinion of the starter motor must first engage in the toothed ring of the flywheel of the internal combustion engine every time before the start procedure takes place. This results in a greater mechanical load on the pinion and the toothed ring when the pinion engages, and during start-up, due to the high rotational acceleration. This is the case in particular with a “tooth on tooth” position, because the pinion is then moved into the toothed ring of the engine when the starter motor is at full acceleration. In addition, a time delay occurs every time the internal combustion engine is restarted, since the pinion must first engage in the toothed ring before the engine is actually turned over.

In addition, publication EP 08 48 159 A1 makes known to bring the starter pinion into the engagement position at the beginning of a stop state, so that the starter motor may then be switched on immediately and with full force when the start state begins. In this manner, the time to turn the internal combustion engine over is reduced considerably. Electronic means may also be used to limit the starting current of the starter motor. The engagement procedure of the starter relay takes place with relatively high dynamics, in order to ensure reliable functioning in all operating states. In particular, the relay winding is designed such that an adequate magnetic potential and pulling force are ensured, even at the upper limiting temperature. In general, the starter relay is therefore operated with a high level of energy, which results in increased noise emissions. Even the preliminary engagement of the pinion that takes place with the engine at a standstill results in a clearly noticeable “clack” sound as soon as the solenoid switch starts and the starter pinion strikes the toothed ring axially, or when it strikes a tooth flank of the toothed ring when engagement takes place during rotation. This is irritating and unpleasant to the driver. The requirements placed on the starting relay with regard for non-destructive, quiet engagement and for attaining a high contact pressure to switch on the starter motor conflict with each other, however, and they have not been adequately covered with previously known starter relays. It is known to control the engagement of the starter pinion using an actuating device and the turning over of the engine using a starter motor independently of each other using two switching elements of a starting device. This requires additional space and costs, however.

The object of the present invention is to control the starter relay in an automatic start-stop system such that the noise produced during the engagement procedure is greatly reduced at the beginning of a stop phase and, at the beginning of the start phase, the switch contact of the relay is closed with adequate contact pressure to switch on the starter motor.

### ADVANTAGES OF THE INVENTION

The inventive starting device with the characterizing features of claim 1 has the advantage that, via the two-stepped actuation of the starter relay, initially when the stop phase begins and until preliminary engagement of the starter pinion, the starter relay engages the starter pinion in the toothed ring of the engine across a first displacement section with low dynamics and decreasing pulling force with the switch contact open and with much less noise. The switch contact of the starter relay is not closed until the beginning of the start phase, in the final displacement section and with full dynamics, thereby switching the starter motor on. As a result, separate control of the starter relay and the starter motor using semiconductor switches—which require a lot of space and are expensive—is prevented. A further advantage is the fact that a gentle engagement of the starter pinion may greatly reduce the wear on the mechanical parts.

Advantageous embodiments and refinements of the features indicated in claim 1 result from the measures listed in the subclaims.

To reduce the relay dynamics, in the first step, the excitation current of the relay winding is easily reduced from an initial value to the holding current by a control unit via a switching element, preferably in a stepped manner. The starter pinion now remains engaged in the toothed ring during the stop phase of the engine. When the start phase begins, the excitation current of the starter relay is then increased, in the second step, to a value required for the necessary contact pressure of the switch contact.

In an advantageous refinement of the present invention, the starter relay is designed—in order to stop the armature after the starter pinion engages, in the stop phase—such that the magnetic force generated by the holding current in the first displacement section of the armature is greater than the force of the preloaded armature return spring, but it is less than the force of a further, preferably preloaded return spring that acts along the final displacement section of the armature. The preload force of the further return spring is advantageously chosen such that the armature does not overcome it until more current is supplied to the starter relay for the final displacement section. It may also be advantageous, with additional expenditure and in the first step of a starting procedure, for the starter motor to be directly controllable using a further switching element of the control unit to turn the starter pinion in the toothed ring of the engine.

In order to engage the starter pinion in the toothed ring of the engine as gently and quietly as possible in the stop phase of the motor vehicle, the magnetic circuit of the starter relay is designed such that—in a spring-loaded displacement region of the armature and before the switch contact closes—the displacement of the armature is nearly proportional to the magnetic potential. For this purpose, the magnetic circuit is advantageously designed such that the armature extends concentrically over magnetic core in its last displacement region, with a small radial air gap between them. Advantageously, the armature is provided—on its front end face facing the magnetic core—with an axially projecting collar, which engages in the rear displacement section of the armature via the front end of the magnetic core.

In order to reliably hold the starter pinion in the engaged position and to hold the switch contact of the starter relay in the opened state during a stop phase, it is provided in a refinement of the present invention that the armature of the starter relay may bear against the further return spring at the end of the first displacement section. This results in a spring characteristic for the starter relay that has a step—after the first displacement section of the armature, when the preloaded, further return spring is reached—which is not overcome until full current is supplied to the starter relay for the second displacement section of the armature. A contact reset spring of the starter relay advantageously serves as the further return spring, which is actuated by the armature via a switch rod.

As an alternative, it is also possible, in order to start the engine as quickly as possible, to move the switch contact forward—in the first displacement section of the armature—until slightly before closing, and to hold it there using the preloaded, further return spring during the stop phase. For this case, a contact pressure spring of the starter relay may be advantageously used as the further return spring, and, in the first step, the switch rod on which the switch contact is installed is moved forward until it bears against the contact pressure spring.

### DRAWING

The present invention is explained below in greater detail, as an example, with reference to the attached drawing.

FIG. 1 shows a schematic depiction of the starting device for internal combustion engines in a general embodiment of the present invention,

FIG. 2 shows, in a first exemplary embodiment, a longitudinal cross section through a starter relay of the starting device according to FIG. 1,

FIG. 3 shows various displacement-force curves of the starter relay according to FIG. 2,

FIG. 4 shows the main variables of a start-stop procedure plotted against time,

FIG. 5 shows, in a schematicized depiction, the starting device (a) in the resting state, (b) in the engaged state, and (c) in the start state.

FIG. 6 shows, in a further exemplary embodiment, a modified starter relay, in a longitudinal sectional view,

FIG. 7 shows the displacement-force curves of the starter relay according to FIG. 6, and

FIG. 8 shows, in a schematicized depiction, the starting device (a) in the resting state, (b) in the engaged state, and (c) in the start state.

### DESCRIPTION OF THE EXEMPLARY EMBODIMENTS

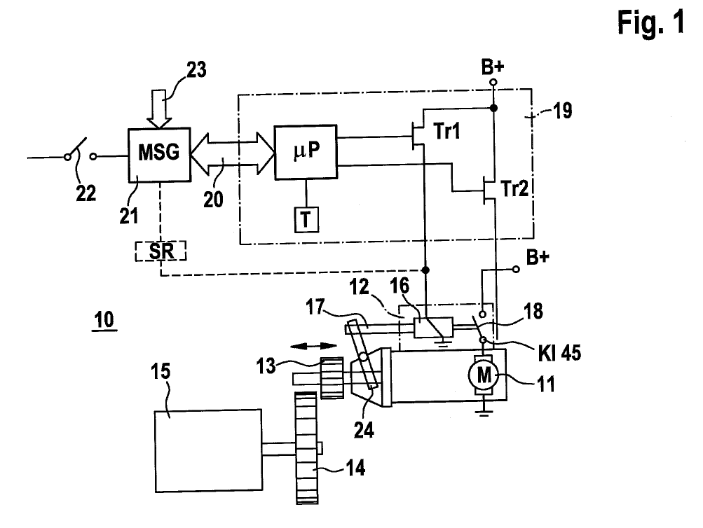

FIG. 1 shows, in a schematicized depiction, an inventive starting device—labeled with reference numeral 10—for internal combustion engines in motor vehicles. It essentially includes a starter motor 11, a starting relay 12, and a starter pinion 13 for engaging axially in a toothed ring 14 of an internal combustion engine 15, and a control unit 19. Starter relay 12 includes a relay winding 16, a plunger 17, and a switch contact 18 for switching the main current for starter motor 11. Control unit 19 supplies relay winding 16 with current via a transistor Tr1. Separately from this, starter motor 11 is controlled directly by control device 19 by a further transistor Tr2 via terminal KI45. Transistors Tr1 and Tr2 are connected, on the input side, via terminal B+, to the positive pole of the vehicle power supply of the not-shown motor vehicle, and to the positive pole of a storage battery of the motor vehicle. Transistors Tr1 and Tr2 are controlled at their control connections separately from each other via a microprocessor μP, which is controllable on the input side by an engine control unit 21 via a control bus 20. Engine control unit 21 is activatable via an ignition lock 22 and registers—via an input bus 23—various signals regarding the driving state of the motor vehicle, e.g., a clutch actuation, a brake actuation, the position of a gear-selection lever, the engine speed, wheel speed, and the like. The microprocessor of control device 19 is also connected with a temperature sensor T, which registers the temperature of the starting device 10.

Starting device 10 is controlled during the driving operation of a motor vehicle by engine control unit 21 by its shutting off the internal combustion engine at the beginning of a stop phase of the motor vehicle. This is accomplished, e.g., by registering the rotational speed of the front wheels of the motor vehicle. To this end, in a first step, control unit 19 initiates—via control bus 20—an engagement procedure of starting pinion 13 in toothed ring 14 of engine 15 by a metered excitation current being supplied via transistor Tr1 to starter relay 12. Starter pinion 13 is now pushed forward axially by plunger 17 and an engagement lever 24 until it engages in toothed ring 14. In addition, starter motor 11 is controlled in a metered manner by control unit 19 via transistor Tr2 via engine terminal KI 45, so that—when a tooth-on-tooth position exists—starter pinion 13 is rotated gently into the next tooth gap. Starter pinion 13 now engages completely and quietly in toothed ring 14 of engine 15, and it is held in this position by starter relay 12. Switch contact 18 remains in the opened position. When it is detected that the driver wishes to start, e.g., via an actuation of the gas pedal, and via a signal which is therefore sent by engine control unit 21 to control unit 19, starter relay 12 is controlled with increased current via transistor Tr1 in a second step, to start engine 15, and switch contact 18 is therefore closed with full force. Starter motor 11 is therefore connected via switch contact 18 of starter relay 12 with terminal B+ of the not-shown storage battery, and internal combustion engine 15 is turned over immediately, with full force.

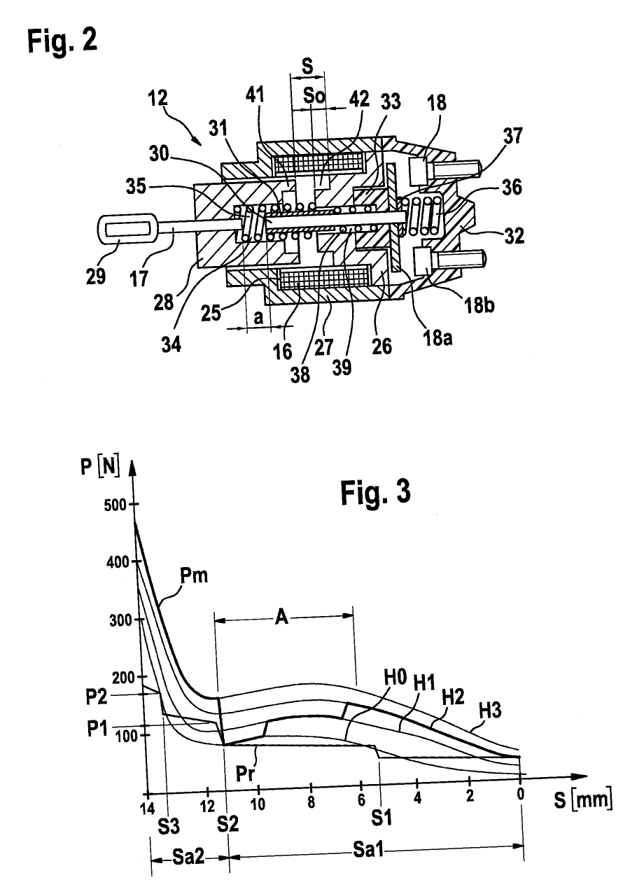

FIG. 2 shows, in a first exemplary embodiment, the design of starter relay 12 according to FIG. 1, in a longitudinal sectional view. Starter relay 12 includes a relay winding 16, which is installed on a carrier body 25 on a magnetic core 26. Relay winding 16 is inserted in a metallic housing 27, in the front, open end of which magnetic core 26 is accommodated. An armature 28 of the relay is guided axially into an opening at the base of housing 27 and enters relay winding 16. Plunger 17 is secured in a central bore of armature 18, the top end of which includes a paddle 29 for receiving an engagement lever 24 (FIG. 1). A switch rod 30 is guided in a through-hole of magnetic core 26 using an insulating sleeve 31, the front end of the switch rod being located opposite to the end of plunger 17 at a distance a. A contact bridge 18a is accommodated in an axially displaceable manner at the rear end of switch rod 30, and interacts with two countercontacts 18b installed in a switch cover 32. In its rest position shown, contact bridge 18a bears via an insulation cap 33 against magnetic core 26. Contact bridge 18a and countercontacts 18b therefore form switch contact 18 of the engagement relay, which is enclosed by switch cover 32, which is mounted on the end face of housing 27.

An armature return spring 35 is located in an axial recess 34 of armature 28, and bears against the bottom of recess 34 and against magnetic core 26 of the relay. In addition, a contact return spring 36 is installed in switch cover 32 in a manner known per se; it bears against the base of switch cover 32 and against a supporting ring 37 installed on the right end of switch rod 30. A contact pressure spring 38 is located in an axial recess 39 on the right side of magnetic core 26. Spring 38 bears against contact bridge 18a via insulation cap 33 and against insulating sleeve 31 on switch rod 30. All three springs are preloaded. Contact reset spring 36, which has the greater preload, holds contact bridge 18a pressed against the preload of contact pressure spring 38 in the rest position shown.

In order to engage starter pinion 13 in toothed ring 14 of engine 15 as quietly as possible at the beginning of a stop phase of the motor vehicle, the magnetic circuit of starter relay 12 is designed such that, in a central region of armature displacement s, a change in displacement is attained that is nearly proportionally to the change in the magnetic potential of relay winding 16. To this end, armature 28 extends concentrically over magnetic core 26 in its last displacement region so with a small radial air gap between them. Armature 28 is therefore provided with an axially projecting collar 41 on its front end face, which faces magnetic core 26. Collar 41 enters a recess 42 along the final displacement region so. Recess 42 is formed in the circumference of magnetic core 26 and is located opposite to collar 41 of armature 28.

To explain the mode of operation in greater detail, FIG. 3 shows various characteristic curves of starter relay 12. The spring characteristic of starter relay 12, as restoring force Pr, and the force characteristics of the starter relay at various magnetic potentials H0 through H3 are shown plotted against displacement s of armature 28. Restoring force Pr is directed against the magnetic force of the relay.

Starting from the rest position of armature 28 as shown in FIG. 2, the preload of armature reset spring 35 must first be overcome. An axial forward motion of armature 28 initially only causes armature reset spring 35 to be pressed together by approximately 6 mm to position S1, and the spring force initially increases slightly and linearly. In this position, plunger 17 engages in engagement lever 24 (FIG. 1) and moves starter pinion 13—with a slight amount of friction—so far forward that it may engage in toothed ring 14 of internal combustion engine 15. Armature 28 of starter relay 12 moves to position S2. In this position, the armature has crossed distance a between plunger 17 and switch rod 28 and now presses via switch rod 30 against preloaded contact reset spring 36, which serves as a further reset spring for armature 28. Before the armature may move further, force P1 must also reach the preload of contact reset spring 36. With a steeper increase in force, contact bridge 18a is pushed from position S2 approximately 2 mm until it reaches countercontacts 18b, thereby loading contact reset spring 36 further. In position S3, switch contact 18 closes, in order to switch on starter motor 11. Subsequently, until armature 28 reaches magnetic core 26, contact pressure spring 38 is loaded further with force P2 for the burn-off reserve of switch contact 18.

The four force characteristic curves of the magnetic potential of the armature across armature displacement s extend nearly parallel with each other. The characteristic with the greatest magnetic potential H3 is selected—using a particular design of relay winding 16 and a particular current via transistor Tr1 of control unit 19—such that it is located far above spring characteristic Pr of the relay across entire armature displacement s. By designing starter relay 12 with collar 41 of armature 28—which extends across recess 42 of magnetic core 25—a nearly horizontal shape of characteristics H0 through H3 is attained in a central displacement region A, which is located approximately between positions S1 and S2. It is therefore possible to attain a change in displacement ΔS of armature 28 that is approximately proportional to magnetic potential ΔH in this region of the displacement of the armature. As a result, by metering the excitation current in the first step of pre-engagement, the magnetic potential may be reduced up to characteristic H0 to the extent that starter pinion 13 is engaged in toothed ring 14 with minimal noise in first displacement section Sa1 of armature 28 up to position S2. Preloaded contact reset spring 38 also ensures that armature 28 is held in position S2 with switch contact 18 open during a stop phase of the motor vehicle. When a starting signal occurs, control unit 19 increases the magnetic potential of the relay to characteristic H3, and switch contact 18 is then closed—with high dynamics and full force—across second displacement section Sa2 of armature 28 at the beginning of the second step, to switch on starter motor 11.

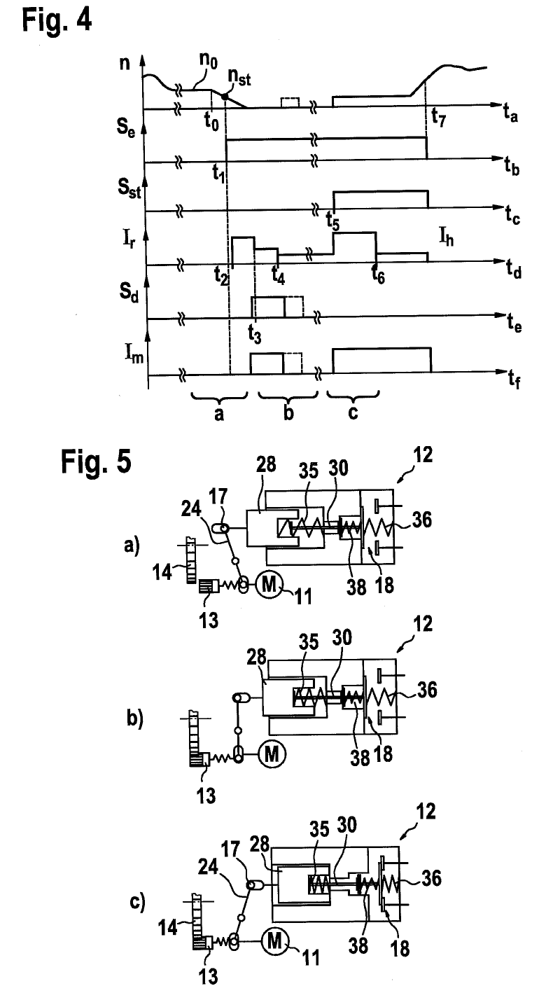

FIG. 4 shows the various signal graphs of the inventive starting device during a stop and start phase. Engine speed n of the internal combustion engine is plotted on upper time axis ta. Below that, an engagement signal Se for pre-engaging the starter pinion is plotted on time axis tb. Below that, a start signal Sst is plotted on time axis tc, and current Ir in the relay winding of the starter relay is plotted on time axis td. Below that, a turning signal Sd for the starter motor for turning the starter pinion in the toothed ring is plotted on time axis te. The course of engine current intensity Im at the starter motor is plotted on lower time axis tf.

The description of a stop and start phase is explained in greater detail with reference to FIG. 4 in conjunction with FIGS. 1 through 3 and FIG. 5. In FIG. 5, the starting device is depicted schematically in its rest position (a), in its engagement position (b), and in its starting position (c).

When the motor vehicle, in driving operation, is stopped, e.g., at a red traffic light, engine control unit 21 according to FIG. 1 detects via a sensor that the driven wheels of the motor vehicle have come to a standstill. If the clutch is also actuated and no-load speed n0 of internal combustion engine is detected, engine control unit 21 shuts off the internal combustion engine at time t0 (FIG. 4). The engine speed signal now drops to engine speed 0, e.g., within one second. When the engine runs down, the engine control unit detects the stop phase of engine 15 when stop engine speed nₛₜ is reached at time t1, and an engagement signal Se is sent to control unit 19 via control bus 20. At this point in time, as shown in FIG. 5a), starter relay 12 is still in the rest position, and starter pinion 13 is still disengaged from toothed ring 14 of engine 15 via engagement lever 24. Immediately thereafter, at time t2, transistor Tr1 is activated by microprocessor μP such that relay winding 16 is acted upon initially with a relatively high relay current Ir, in order to set the armature mass in motion against the restoring force of preloaded armature reset spring 35. The graph of magnetic force Pm of starter relay 12 shown in bold in FIG. 3 initially follows magnetic potential characteristic H2. After free travel of plunger 17, starter pinion 13 is pushed by relay armature 28 via engagement lever 24 until it reaches toothed ring 14. At time t3, control unit 19 reduces relay current Ir by one level via transistor Tr1. As a result, magnetic force Pm is also reduced, i.e., it falls to magnetic potential characteristic H1 shown in FIG. 3. Since this magnetic force is still much higher than restoring force Pr of armature reset spring 35, armature 28 is pulled even further into relay winding 16. At nearly the same time, microprocessor μP activates transistor Tr2 of control unit 19 to the extent that starter motor 11 is now supplied with low current intensity Im via transistor Tr2. Starter pinion 13 is then rotated gently and is engaged axially—and gently—with toothed ring 14 via the engagement lever. At time t4, relay current Ir is reduced by one more level. Accordingly, magnetic force Pm of starter relay 12 drops from magnetic potential characteristic H1 to magnetic potential characteristic H0. With this magnetic force, armature 28 is now pulled in to position S2, where it bears via plunger 17 against switch rod 30, which is loaded with the preload of contact reset spring 36. Starter relay 12 remains at a standstill in this position for the duration of the stop phase of the internal combustion engine. FIG. 5b) shows the starting device in this pre-engagement position. Switch contact 18 is in the opened position. Transistor Tr2 of control unit 19 is now blocked again, and current is not supplied to starter motor 11.

When the traffic light turns green, the driver need only actuate the gas pedal, and engine control unit 21 outputs a start signal to control unit 19 at time t5. Microprocessor now activates transistor Tr1 fully, and full excitation current Ir is applied to relay winding 16 of starter relay 12. As a result, as shown in FIG. 3, magnetic force Pm jumps up from magnetic potential characteristic H0 to characteristic H3, thereby clearly exceeding restoring force Pr of springs 35, 36 and 38 of starter relay 12. Armature 28 is now pulled in with full force until it strikes magnetic core 26. In second displacement section Sa2 (FIG. 3), contact bridge 18a is therefore pressed via switch rod 30 against countercontacts 18b, and the necessary contact pressure is generated by contact pressure spring 38. Starter motor 11 is now connected to the positive potential of the storage battery, thereby enabling starter motor 11 to turn internal combustion engine 15 over with full force, via engagement pinion 13. This “starting phase” of the starting device is depicted in FIG. 5c). Engagement pinion 13 is held in the engagement position with preload via engagement lever 24. At time t0, relay current Ir may be lowered by control unit 19 via transistor Tr1 to holding current Ih, since this is sufficient to generate a magnetic force Pm that lies above spring characteristic Pr of starter relay 12. As soon as the internal combustion engine enters sustained operation, the engine speed increases greatly when the gas pedal is actuated. When no-load speed no is reached, transistor Tr1 is therefore blocked by control unit 19 at time t7. The relay becomes de-energized, and armature 28 is pushed back to its rest position via the restoring forces of springs 35, 36 and 38. Switch contact 18 is opened, and engagement pinion 13 is disengaged from toothed ring 14 of internal combustion engine 15. The current of starter motor 11 is interrupted, thereby bringing the starter motor to a standstill. The starting device therefore returns to its rest position shown in FIG. 5a) and remains there until internal combustion engine 15 is brought to a standstill for another stop phase, and the engagement and starting procedure described above is carried out once more.

In the first exemplary embodiment, as shown in FIGS. 2 through 5, contact reset spring 36 of starter relay 12 is used as a further return spring for armature 38, which holds starter pinion 13 in the engaged position in the stop phase. Switch contact 18 of starter relay 12 remains in its rest position—i.e., its open position—due to the preload force of contact reset spring 36, When the start phase begins, switch contact 18 is closed with full force, in the second step of starter relay 12, by increasing the current in relay winding 16 to a value required for the necessary contact pressure of switch contact 18.

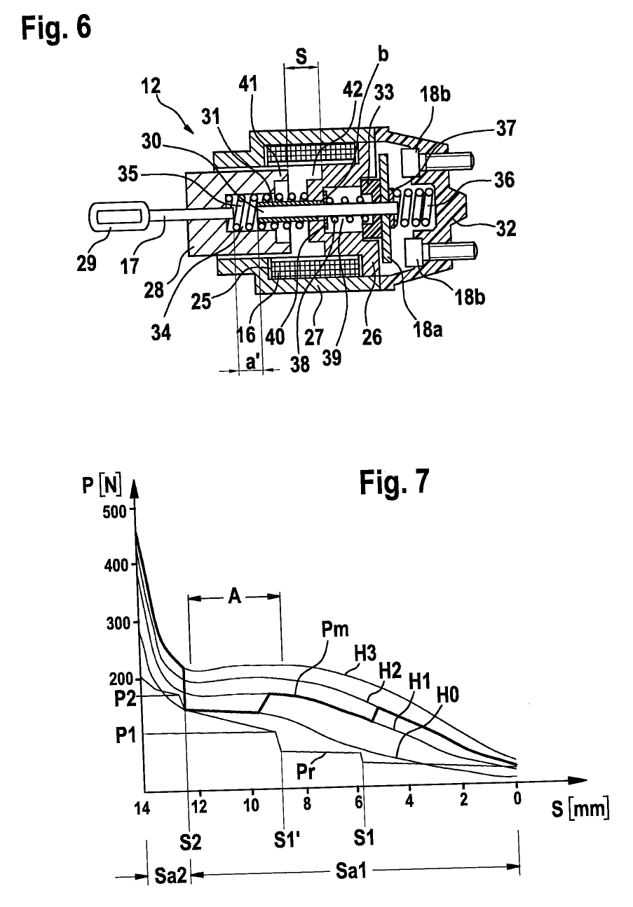

FIG. 6 shows, in a further exemplary embodiment, a cross section of a starter relay 12, the design of which essentially corresponds to that of starter relay 12 in FIG. 2, and the components of which are labeled with the same reference numerals. In deviation from the first exemplary embodiment, with the starter relay shown in FIG. 6, a smaller distance a′ is provided between plunger 17 of armature 8 and switch rod 30 of switch contact 18. In addition, contact pressure spring 38 also bears against annular disk 40. In the rest position of the relay, annular disk 40 lies on the bottom of recess 39 of magentic core 26 and is accommodated on switch rod 30 in an axially displaceable manner. Insulating sleeve 31 of switch rod 30 ends a distance b below annular disk 40. As a result of this design modification, the spring restoring force of starter relay 12 also changes along armature displacement s.

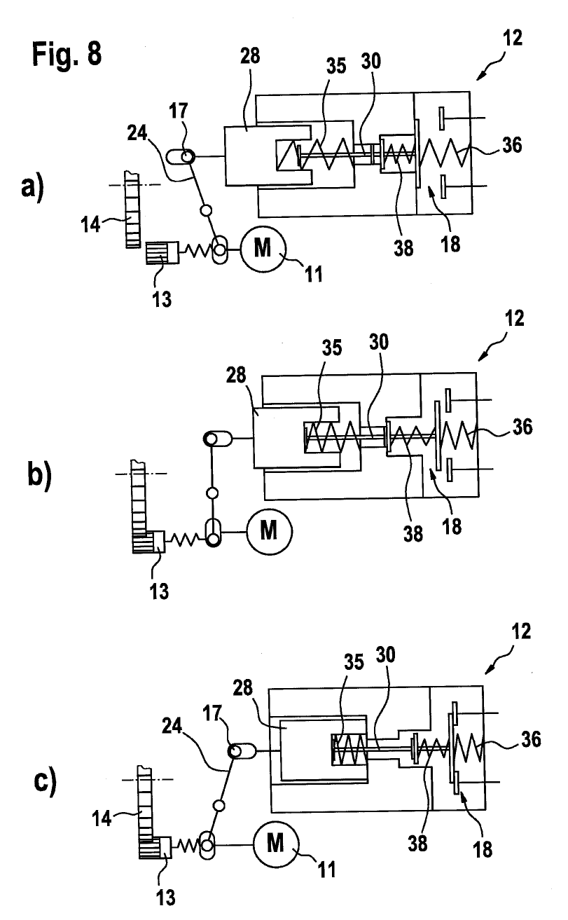

The mode of operation of the relay depicted in FIG. 6 will now be described in greater detail with reference to FIGS. 7 and 8. FIG. 7 shows the spring characteristic of starter relay 12 as restoring force Pr along displacement s of armature 28, and the force characteristics of the starter relay at various magnetic potentials H0 through H3. Similar to FIG. 5, FIG. 8 shows the starting device in a schematic depiction, in the rest position (a), in the engagement position (b), and in the starting position (c).

Starting from the rest position of armature 28 as shown in FIG. 6 and FIG. 8 a), the preload of armature reset spring 35 must first be overcome. An axial forward motion of the armature therefore compresses armature reset spring 35 by approximately 4 mm to position S1, with the spring force initially increasing slightly and linearly. In this position, as shown in FIG. 1, starter pinion 13 is now pushed forward by engagement lever 24 and, when a slight amount of current is supplied to starter motor 11, it is engaged in toothed ring 14 of internal combustion engine 15. Armature 28 of starter relay 12 moves initially to position S1′ shown in FIG. 7, where plunger 17 of armature 28 now strikes switch rod 30, which is held in this position with a force P1 via the preload of contact reset spring 36. Up to this position, the excitation current is now reduced in a stepped manner by reducing the magnetic potential from characteristic H2 to H0. In contrast to the first exemplary embodiment, magnetic force Pm generated by magnetic potential H0 is greater than the preload force of contact reset spring 36, and the armature is therefore now moved past position S1, to position S2. In this position, insulating sleeve 31 of switch rod 30 strikes annular disk 40, against which preloaded contact pressure spring 38 bears. Via the displacement of armature 28 from position S1′ to position S2, contact bridge 18a is moved forward by switch rod 30 to a position shortly before it touches countercontacts 18b. Due to magnetic force H0, the magnetic force is now so low that armature 28 is held in this position for the duration of the stop phase of the motor vehicle.

Before the armature may move further, the preload of contact reset spring 38 must be overcome with force P2. This takes place at the beginning of the start phase, in which the magnetic force of the relay is increased to characteristic H3 by supplying full current to relay winding 16. As a result, starting from position S2, contact bridge 18a is pushed forward with a steeper increase in force up to countercontacts 18b and loads contact pressure spring 38 further for the necessary contact pressure, until armature 28 strikes magnetic core 26.

In this exemplary embodiment, contact pressure spring 38 serves as a further reset spring for armature 28, with which the starting device is held in the engagement position of the starter pinion with switch contact 18 open. Since, with this design, switch contact 18 is raised during the stop phase until shortly before it closes, the engine is therefore turned over nearly immediately in the start phase, due to the immediate closing of switch contact 38 to supply full current to starter motor 11.

The present invention is not limited to the exemplary embodiments described, since the starting device may be modified in terms of numerous details. It is possible, for example, to control starter relay 12 and/or starter motor 11 in a cyclically actuated manner during pre-engagement and in the holding phase. In this case, transistors Tr1 and Tr2 are preferably controlled by microprocessor μP with a modified on/off ratio to limit the switching losses. In addition, in this manner and via temperature sensor T of control unit 19, the current of starter relay 12 and starter motor 11 may be optimized in a temperature-dependent manner for the force required. It is also possible to control starter motor 11 for a longer period of time—using an extended turnover signal Sd shown as a dashed line in FIG. 4—so that, after starter pinion 13 is rotated in toothed ring 14 of internal combustion engine 15, internal combustion engine 15 is rotated further until a compression position has been reached. This is also indicated, as a dashed line, on time axis ta of engine speed n. As a result, the starting procedure of internal combustion engine 15 may be accelerated further. An essential aspect of the present invention is the dynamic behavior of starter relay 12 by the control of the relay current via control unit 19 in combination with a suitable spring design of starter relay 12, in order to subdivide the pulling-in and switching procedure of the relay into two steps such that, in the first step, it is ensured that starter pinion 13 is pulled in in a linear, noise-minimized manner, thereby resulting in gentle pre-engagement in toothed ring 14 of internal combustion engine 15. The magnetic circuit is designed such that the relay current required for the magnetic potential remains as low as possible. In addition, the remaining air gap of the magnetic circuit—and, associated therewith, the contact distance between switching bridge 18a and countercontacts 18b—must be minimized in the holding position of the relay, for the duration of pre-engagement. The magnetic potential of the relay is increased in step two such that contact reset spring 36 and contact pressure spring 38 are bridged, and switch contact 18 is closed to switch the main current for starter motor 11.

In the exemplary embodiments, the contact reset spring and the contact pressure spring for switch contact 18 of relay are used for further reset spring 38, which is activated at the beginning of the second step of starter relay 12. The further reset spring—or a separate reset spring—may be located, e.g., concentrically with the armature reset spring such that it is not acted upon by armature 28 with a large magnetic force until the beginning of the second step. In any case, the various springs in the relay must be matched such that a stepped spring characteristic Pr results, as shown in FIGS. 3 and 7. It is also possible to design the steps of the spring characteristic to be more or less strongly pronounced at the beginning of the second step of starter relay 12.

In a further modification of the starting device, it is also possible for relay winding 16 of starter relay 12 to be switched on directly by engine control unit 21 in the second step of a starting procedure at time t5 shown in FIG. 4 using a control relay SH, in the same manner as for a cold start of the engine, as indicated with a dashed line in FIG. 1.

What is claimed is:

1. A starting device (10) for motor vehicles with a control unit (19) and a starter relay (12) for engaging a starter pinion (13) in a toothed ring (14) of an internal combustion engine (15), and with a starter motor (11) that drives the starter pinion, the starter relay including a relay winding (16) and a switch contact (18) that switches the main current of the starter motor, in which—in a start-stop procedure—the starter pinion engages in the toothed ring during the stop phase in a first step (Sa1) and, during the start phase, in a second step (Sa2), the internal combustion engine is turned over by the starter motor,
wherein,
in the first step (Sa1), during preliminary engagement of the starter pinion (13), the armature (28) of the starter relay (12) is moved forward with reduced force to a position (S2)—with the switch contact (18) still open—and it is held there until the start of the second step (Sa2), at which point the switch contact (18) closes with full force.

2. The starting device as recited in claim 1,
wherein,
in the first step (Sa1), the control unit (19) reduces the current (Ir) in the relay winding (16) via a switch element (Tr1) from an initial value to a half-current, preferably in a stepped manner, and, in the second step (Sa2), it increases the current (Ir) to a value required for the necessary contact force of the switch contact (18).

3. The starting device as recited in claim 2,
wherein
the magnetic force (Pm) generated by the holding current in the first displacement section (Sa1) of the armature (28) is greater than the force of the preloaded armature return spring (35), but it is less than the force applied by a further return spring (36, 38), which is preferably preloaded and acts in the final displacement section (Sa2).

4. The starting device as recited in claim 3,
wherein
the preload force of the further return spring (36, 38) need not be overcome until an increased amount of current is supplied to the starter relay (12) for the final displacement section (Sa2) of the armature (28).

5. A starter relay for a starting device as recited in claim 1,
wherein
the magnetic circuit of the starter relay (12) is designed—in a spring-loaded displacement region (A) of the armature (28), before the switch contact (18) is closed—for a displacement (ΔS) of the armature (28) that is nearly proportional to the magnetic potential (ΔH).

6. The starter relay as recited in claim 5,
wherein
the armature (28) extends concentrically over magnetic core (26) of the starter relay (12) in its last displacement section (Sa2), with a small radial air gap between them.

7. The starter relay as recited in claim 6,
wherein
the armature (28) is provided—on its end face facing the magnetic core (26)—with an axially projecting collar (41), which extends over the front end of the magnetic core (26) in the rear displacement section (Sa2) of the armature (28).

8. Starter relay for a starting device as recited in claim 3,
wherein,
at the end of the first step, the armature (28) of the starter relay (12) bears against the further return spring (38).

9. The starter relay as recited in claim 8,
wherein
a contact return spring (36) of the starter relay (12) serves as the further return spring, which is actuated by the armature (28) via a switch rod (30).

10. The starter relay as recited in claim 8,
wherein
the switch contact (18) is moved forward—in the first displacement section (Sa1) of the armature (28)—until slightly before closing, and it is held there during the stop phase by the preloaded, further return spring (36).

11. The starter relay as recited in claim 10,
wherein
a contact pressure spring (36) of the starter relay (12) serves as the further return spring.

12. The starter relay as recited in claim 11,
wherein,
in the first step (Sa1), the switch rod (30) on which the switch contact (18) is mounted is capable of being moved forward until it bears against the contact pressure spring (36).
